(19) United States
(12) Patent Application Publication
(10) Pub. No.: US 2024/0242855 A1
(43) Pub. Date: Jul. 18, 2024

(54) Power cable with non-metallic tape armour

(71) Applicant: PRYSMIAN S.P.A., Milano (IT)

(72) Inventors: Enrico Maria CONSONNI, Milano (IT); Alessandro CONTE, Milano (IT); Piervincenzo COSTAGLIOLA, Milano (IT); Stefano FRANCHI BONONI, Milano (IT)

(73) Assignee: PRYSMIAN S.P.A., Milano (IT)

(21) Appl. No.: 18/415,132

(22) Filed: Jan. 17, 2024

(30) Foreign Application Priority Data
Jan. 18, 2023 (IT) 102023000000684

(51) Int. Cl. H01B 7/18; H01B 7/02; H01B 9/02

(52) U.S. Cl. CPC H01B 7/1855; H01B 7/0225; H01B 7/0283; H01B 7/188; H01B 7/1895; H01B 9/027

(57) ABSTRACT

Provided is a power cable that contains at least one insulated conductor extending along a cable longitudinal direction; a bedding layer surrounding the at least one insulated conductor, and a non-metallic armour surrounding the bedding layer. The non-metallic armour is made by at least one meshed tape helically wound onto the bedding layer and has an openness factor of at least 30% and a meshed tape tear resistance of at least 200 N according to DIN 53363 of 2003.

### BACKGROUND OF THE DISCLOSURE

The present disclosure refers to a power cable with non-metallic tape armour particularly but not exclusively suitable for underwater deployment.

In the present description reference will be made to AC (alternate current) power cables for underwater deployment at low depth, e.g. lower than 500 m, but all the following considerations can be applied also to any type of power cable.

Typically, a power cable includes at least one cable core usually formed by an electrically conductive metal conductor covered by an insulation system. The insulation system can be sequentially formed by an inner polymeric semiconductive layer, an intermediate polymeric insulating layer, and an outer polymeric semiconductive layer. The insulation system is usually then surrounded by a metallic screen generally made of lead and/or copper and, optionally by a semiconductive sheath. A bedding layer, for example made of wound polymeric yarns or tapes, may surround the at least one core. When the power cable comprises more than one cable core, i.e. three cable cores, the power cable may also comprise a filler material or shaped filling elements between the cores that are together surrounded by the bedding layer.

In any case the bedding layer is then surrounded by an armour which is designed in view of the intended application and which can be surrounded by a serving layer.

For example, in case of deployment at low depth (like 200 m) the armour can be made of a single layer of steel wires surrounded by bituminous polypropylene yarns as a serving layer in order to avoid abrasion.

In the case of low-depth cable, the main aim of the armour is to provide protection against lateral stress, i.e. against impact and crushing. However metallic armours, besides being a heavy portion of the cable, can be a source of power loss in AC cables. This could be avoided by using amagnetic metals but these are generally quite more expensive. As an alternative, the armour can be made of a m ferromagnetic or, better, amagnetic metal wires and dielectric wires, e.g. fiberglass coated polyethylene wires: such a mixed armour is less expensive than that made of amagnetic metal only, but also less performing in terms of meshed tape tear resistance and of heat dissipation as the dielectric wires generally have a thermal conductivity lower than the metallic wires.

An armour can be made of solely dielectric wires, for example in form of fiberglass coated polyethylene wires having a round cross-section. This kind of armour is even more economic and light, but the above mentioned problems of low meshed tape tear resistance and thermal conductivity increase.

Another problem relates to the manufacturing of a wire armoured cable, especially for “big” cable, for example cables for a voltage greater than or equal to 220 kV and/or with conductors having each a cross-section greater than or equal to 1000 mm2.

Indeed for such big cables it is necessary to arrange one or more bobbin for each wire depending on the size of the cable. Depending on the size of the cable to be armoured, it could be necessary to stop the manufacturing line several times to replace the empty bobbin and jointing the wires.

For example, when each bobbin contains 3 km of one armour wire and when an armoured cable 20 km-long and with an armour layer made of 110 wires is to be produced, the manufacturing lines should be stopped from about 50 up to about 100 times every 3 km to replace the empty bobbin and jointing the wires. This clearly reduces the productivity and increases the cost.

GB836660 relates to electric cables for tele-communication purposes, for underground, aerial or submarine installation. In order to render the cable as thin and light as possible, various proposals have been made for reducing the amount of steel wire and using strong insulating materials which in addition to their electrical function also take part of the function of the armour. The use of polypropylene as insulating material for the conductors and as a protective covering so that it can take the mechanical stresses, is highly successful owing to its remarkable characteristics of mechanical strength and its extreme lightness. It enables the steel wire armour to be eliminated entirely in many cases. The cable for telecommunications comprises two or more conductors insulated by an insulating composition consisting at least predominantly of a linear, highly crystalline, polypropylene in the form of a sheath formed by extrusion or applying it in the form of ropes or tapes.

U.S. Pat. No. 7,555,182 relates to an armor laminate for use with a variety of different cable structures. The armor wrap has at least one water absorbing fabric layer, at least one polymer layer, and at least one layer fabricated from a metal. The water absorbing fabric can comprise a carded polyester non-woven material. The polymer layer is ethylene acrylic acid (EAA) or a coextruded blend thereof.

US20160358693 relates to a method for manufacturing a cable. An armor layer is provided between the inner protection jacket layer and the outer protection jacket layer, and the armor layer is formed by lap wrapping a double-layer metal tape along an identical direction with a gap.

WO2022067934 relates to a special degaussing cable for a fixed winding for an underwater vehicle comprising, inter alia, an armour layer which can be made of two layers of tinned copper wire net. The armoring layer is woven from two layers of tinned copper wire mesh with the same specification, the specification of the tinned copper wire mesh is 40/in, the two layers of copper wire mesh are staggered, and the weaving angle is 40 to 60°, the braiding coverage rate is 88%˜92%, the diameter of the single wire of the copper core is 0.2˜0.4 mm, and it is twisted into strands with a pitch ratio of 8 to 10 times, and the strands are twisted in the opposite direction to the original bundle.

### SUMMARY OF THE DISCLOSURE

The Applicant faced the problem of providing a power cable, particularly for submarine applications, with an armour simple to be manufactured and at the same time capable of assuring protection against lateral stress, good heat dissipation and low power losses.

In order to simplify the manufacturing of the cable the Applicant considered to make an armour in form of tape instead of an armour made of a plurality of wires. But a metal tape still gives problems of power loss and could not provide the sought protection against side stress. An amagnetic metal tape reduces the power loss problem, but not that of the lateral protection, besides being more expensive. Thus the Applicant has thought to make the armour with a tape of non-metallic material, in particular, a non-metallic material capable of assuring the protection against lateral stress. However, a non-metallic material generally has a thermal conductivity lower than that of a metal, and an armour in form of a tape of non-metallic material could give rise to overheating problems.

The Applicant experienced that a non-metallic armour in form of a meshed tape with an openness factor of at least 30% and a meshed tape tear resistance of at least 200 N assures a good heat dissipation and suitable protection against lateral stress.

For openness factor it is intended the percentage of perforation in a surface unit. Higher openness percentages indicate a looser fabric weave.

Therefore, according to a first aspect, the present disclosure relates to a power cable comprising:
at least one insulated conductor extending along a cable longitudinal direction;
a bedding layer surrounding the at least one insulated conductor;
a non-metallic armour surrounding the bedding layer, the non-metallic armour being made by at least one meshed tape helically wound onto the bedding layer, and having an openness factor of at least 30% and a meshed tape tear resistance warp/weft of at least 200 N according to DIN 53363 of 2003.

The power cable of the present disclosure can carry either alternate current or direct current.

In an embodiment, the cable of the present disclosure have three insulated conductors twisted one another along the cable longitudinal direction.

In an embodiment, the at least one meshed tape of the present disclosure has a thickness of from 0.5 to 2.5 mm.

The non-metallic armour allows easing the cable manufacturing and increasing the speed thereof. In this way, it is avoided the use of several bobbins that requires high storage space and several changes during the manufacturing since the tape can be stored in pads that are simpler and quicker to be changed with respect to bobbins. Moreover, the number of pads is certainly smaller than the number of bobbins since the tape, typically wider than 10 mm, can cover a surface of the power cable far greater than of a wire (typically having a diameter 6-8 mm). The of manufacturing results to be simpler, faster and cheaper with respect to the wire armours.

For example, for making a 3 km-long cable with 3 insulated conductors, by considering bobbins containing about 800 m of meshed tape, the manufacturing lines has to be stopped about 30 times to replace the empty pad and jointing the tapes, thus much less times with respect to the wire armoured cable.

In addition, the overall diameter of the finished power cable results to be lower with respect to that of a wire armoured cable of the same voltage class, since the thickness of the tape is smaller than the diameter of the wire used for the armours. And it is apparent that also the cable weight is reduced.

Being the non-metallic armour of the present disclosure in form of a meshed tape with the given openness factor, an effective heat dissipation can be achieved in spite of the inherent thermal conductivity of the non-metallic material of the tape.

In an embodiment the non-metallic armour comprises at least two meshed tapes wherein a first meshed tape surrounds the bedding layer and a second meshed tape surrounds the first meshed tape.

In an embodiment the non-metallic armour is made of weft yarns and warp yarns interwoven to each other.

For example, the weft yarns and the warp yarns can be made of a polymeric material such as polyester or polyethersulfone (PES), or of an inorganic and non-metallic material such as glass or carbon fibre, or of a natural material; or of a mixture thereof.

In an embodiment the weft yarns and warp yarns of the meshed tape of the disclosure are coated with a coating.

For example the coating is made of a polymer material such as polyvinylchloride (PVC) or a polyamide; or of a resin such as an epoxy resin.

In an embodiment the at least one meshed tape has an outer surface and an inner surface wherein the outer surface is at least partially coated with a glue.

In this way the adhesion between the meshed tape and the subsequent serving layer is more stable. When the non-metallic armour comprises at least two meshed tapes, the presence of a glue on the outer surface improves the overall stability of the non-metallic armour.

In an embodiment also the inner surface of at least one meshed tape is at least partially coated with a glue.

In this way the adhesion between the meshed tape and the bedding layer is more stable. When the non-metallic armour comprises at least two meshed tapes, the presence of a glue on the inner surface improves the overall stability of the non-metallic armour.

For the purpose of the present description and of the claims that follow, except where otherwise indicated, all numbers expressing amounts, quantities, percentages, and so forth, are to be understood as being modified in all instances by the term “about”. Also, all ranges include any combination of the maximum and minimum points disclosed and include any intermediate ranges therein, which may or may not be specifically enumerated herein.

Also, the terms “a” and “an” are employed to describe elements and components of the disclosure. This is done merely for convenience and to give a general sense of the disclosure. This description should be read to include one or at least one, and the singular also includes the plural unless it is obvious that it is meant otherwise.

As “insulating layer” it is meant a layer made of a material having a conductivity comprised between 10⁻¹⁶ and 10⁻¹⁴ S/m.

As “semiconductive layer” it is meant a layer made of a material having a conductivity comprised between 10⁻¹ and 10 S/m.

The present disclosure, in at least one of the aforementioned aspects, can be implemented according to one or more of the present embodiments, optionally combined together.

### BRIEF DESCRIPTION OF THE DRAWINGS

Further characteristics will be apparent from the detailed description given hereinafter with reference to the accompanying drawings, in which:

FIG. 1 is a schematic perspective view partially sectioned of a power cable according to an embodiment of the present disclosure;

FIG. 2 is a schematic cross-section view of the power cable of FIG. 1.

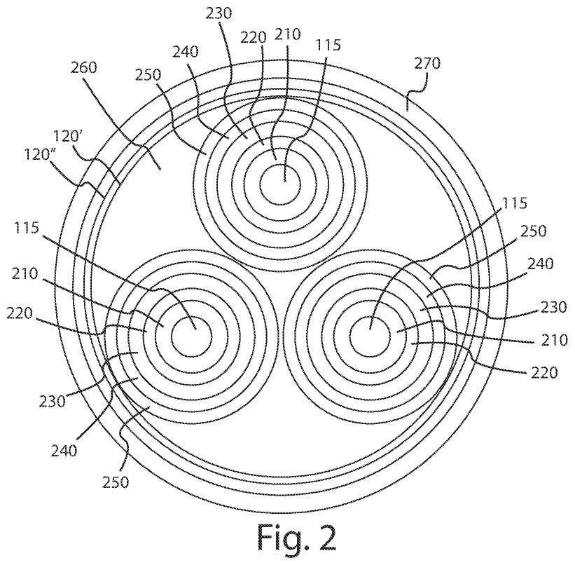

### DETAILED DESCRIPTION OF SOME EMBODIMENTS

With reference to the figures, a power cable according to the present disclosure is schematically represented. The power cable 100 comprises three insulated conductors 110 twisted one another along a longitudinal direction (A).

Each insulated conductor 110 comprises one electric conductor 115 surrounded by a polymeric insulation system 200. Each polymeric insulation system 200 is sequentially formed by an inner polymeric semiconductive layer 210, a polymeric insulating layer 220, and an outer polymeric semiconductive layer 230.

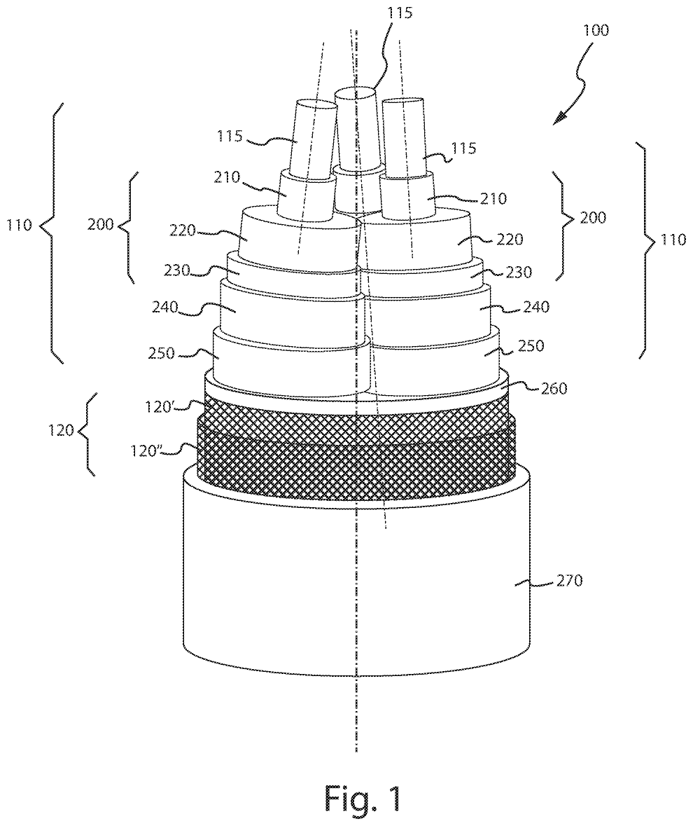

Each insulated conductor 100 may comprise also a metallic screen 240 arranged in a radially outer position with respect to the outer polymeric semiconductive layer 230. A semiconductive sheath 250 may be arranged in a radially outer position with respect to the metallic screen 240 like in the embodiment of FIG. 1.

The three insulated conductors 110 may be twisted to each other forming a cable core and a bedding layer 260 surrounds the three insulated conductors 110.

The power cable 100 also may comprise a filler (not illustrated) placed inside the space between the cable core and the bedding layer 260.

The filler, in particular, may be made of an extruded polymeric material or of polymeric filaments, or may be in form of three shaped elements each defining a plurality of spaces that can be used as seats for optical fiber cables (not illustrated).

A non-metallic armour 120, according to the present disclosure, surrounds the bedding layer 260. In the present embodiment, the non-metallic armour 120 is made by two meshed tapes 120′, 120″ helically wound around the bedding layer 260. Each meshed tape has an openness factor of at least 30% and a meshed tape tear resistance warp/weft of at least 200 N.

As apparent to the skilled person, an increase of the openness factor corresponds to a decrease of the meshed tape tear resistance warp/weft. Thus, a higher limit of the openness factor for the meshed tape of the disclosure is the one corresponding to the minimum value of the meshed tape tear resistance warp/weft. The same applies to the higher limit for the meshed tape tear resistance.

Such higher limit value is the one corresponding to the minimum value of the openness factor.

In the embodiment of FIG. 1, the non-metallic armour is made by two meshed tapes 120′, 120″ wherein a first meshed tape 120′ surrounds the bedding layer 260 according to a first winding direction and a second meshed tape 120″ surrounds the first meshed tape 120′ according to a second winding direction.

The first winding direction may be opposite or may be substantially parallel to the second winding direction.

In an embodiment, a single meshed tape has a thickness of about 0.5 to 2.5 mm. Therefore, for example, in the embodiments with two meshed tapes the overall thickness is about 1 to 5 mm.

The non-metallic armour 120 may be made of polymeric weft yarns and polymeric warp yarns interwoven to each other, optionally coated with a polymeric coating.

The power cable 100 may comprise a serving layer 270 surrounds the outer meshed tape like in the that embodiment of FIG. 1.

Each one of the meshed tapes 120′, 120″ has an outer surface and an inner surface and at least the outer surface of the second meshed tape 120″ is at least partially covered by an adhesive layer (not illustrated) made, for example, by hot-melt glue that results to be placed between the outer meshed tape 120″ and the serving layer 270.

In certain embodiments also the inner surface of at least the first meshed tape 120′ is at least partially covered by an adhesive layer (not illustrated) made, for example, by hot-melt glue that results to be placed between the first meshed tape 120′ and the bedding layer 270.

The outer surface of the first meshed tape 120′ and/or the inner surface of the second meshed tape 120″ may be at least partially covered by an adhesive layer. The presence of an adhesive layer on the outer surface of the first meshed tape 120′ and, at the same time, on the inner surface of the second meshed tape 120″ could be redundant.

In case of a plurality of meshed tapes one surrounding the other it may be provided also a third adhesive layer (not illustrated) made for example by hot-melt glue between two consecutive meshed tape 120′ 120″ like in the embodiment of FIG. 1.

1. A power cable, comprising:
at least one insulated conductor extending along a cable longitudinal direction (A);
a bedding layer surrounding the at least one insulated conductor; and
a non-metallic armour surrounding the bedding layer, the non-metallic armour being made by at least one meshed tape helically wound onto the bedding layer and having an openness factor of at least 30% and a meshed tape tear resistance warp/weft of at least 200 N according to DIN 53363 of 2003.

2. The power cable according to claim 1, which comprises three insulated conductors twisted one another along the cable longitudinal direction (A).

3. The power cable according to claim 1, wherein the at least one meshed tape has a thickness of from 0.5 to 2.5 mm.

4. The power cable according to claim 1, wherein the non-metallic armour comprises at least two meshed tapes, a first meshed tape surrounds the bedding layer, and a second meshed tape surrounds the first meshed tape.

5. The power cable according to claim 1, wherein the non-metallic armour is made of weft yarns and warp yarns interwoven to each other.

6. The power cable according to claim 5, wherein the weft yarns and warp yarns are made of a polymeric material.

7. The power cable according to claim 5, wherein the weft yarns and warp yarns are made of an inorganic and non-metallic material.

8. The power cable according to claim 5, wherein the weft yarns and warp yarns are made of a natural material.

9. The power cable according to claim 5, wherein the weft yarns and warp yarns are coated with a coating.

10. The power cable according to claim 9, wherein the coating is made of a polymer material.

11. The power cable according to claim 1, wherein the at least one meshed tape has an outer surface and an inner surface and the outer surface is at least partially coated with a glue.

12. The power cable according to claim 11, wherein the inner surface of the at least one meshed tape is at least partially coated with a glue.
